(19) United States
(12) Patent Application Publication
(10) Pub. No.: US 2026/0190116 A1
(43) Pub. Date: Jul. 2, 2026

(54) HARQ-ACK Feedback for Network-Controlled Repeaters

(71) Applicant: Apple Inc., Cupertino, CA (US)

(72) Inventors: Ankit Bhamri, Haar (DE); Hong He, San Jose, CA (US); Wei Zeng, Saratoga, CA (US); Dawei Zhang, Saratoga, CA (US); Oghenekome Oteri, San Diego, CA (US); Huaning Niu, San Jose, CA (US); Haitong Sun, Saratoga, CA (US); Yushu Zhang, Beijing (CN); Chunxuan Ye, San Diego, CA (US); Weidong Yang, San Diego, CA (US)

(21) Appl. No.: 19/102,169

(22) PCT Filed: Aug. 9, 2022
(86) PCT No.: PCT/CN2022/111202

§ 371 Date: Feb. 7, 2025

(51) Int. Cl. H04W 72/23; H04L 1/1812

(52) U.S. Cl. CPC H04W 72/23; H04L 1/1812

(57) ABSTRACT

Apparatuses, systems, and methods for a network-controlled repeater (NCR) to provide hybrid automatic repeat request (HARQ) acknowledgment/negative acknowledgment (ACK/NACK) to a base station, in 5G NR systems and beyond. The NCR receives a control message from a base station scheduling resources for an uplink or downlink message. The uplink or downlink message is received, and the NCR determines whether the received message has a signal quality that exceeds a quality threshold. When the signal quality exceeds the quality threshold, the uplink or downlink message is forwarded to the base station or to a UE, respectively. HARQ ACK/NACK feedback is provided to the base station, and may be provided as joint HARQ feedback or separate HARQ messages for each of the control message and the uplink or downlink message. Separate or joint HARQ feedback may be provided when the NCR receives multiple control messages from the base station.

### FIELD

The invention relates to wireless communications, and more particularly to apparatuses, systems, and methods for providing hybrid automatic repeat request (HARQ) acknowledgment (ACK) messaging by a network-controlled repeater, e.g., in 5G NR systems and beyond.

### DESCRIPTION OF THE RELATED ART

Wireless communication systems are rapidly growing in usage. In recent years, wireless devices such as smart phones and tablet computers have become increasingly sophisticated. In addition to supporting telephone calls, many mobile devices now provide access to the internet, email, text messaging, and navigation using the global positioning system (GPS), and are capable of operating sophisticated applications that utilize these functionalities.

Long Term Evolution (LTE) is currently the technology of choice for the majority of wireless network operators worldwide, providing mobile broadband data and high-speed Internet access to their subscriber base. LTE was first proposed in 2004 and was first standardized in 2008. Since then, as usage of wireless communication systems has expanded exponentially, demand has risen for wireless network operators to support a higher capacity for a higher density of mobile broadband users. Thus, in 2015 study of a new radio access technology began and, in 2017, a first release of Fifth Generation New Radio (5G NR) was standardized.

5G-NR, also simply referred to as NR, provides, as compared to LTE, a higher capacity for a higher density of mobile broadband users, while also supporting device-to-device, ultra-reliable, and massive machine type communications with lower latency and/or lower battery consumption. Further, NR may allow for more flexible UE scheduling as compared to current LTE. Consequently, efforts are being made in ongoing developments of 5G-NR to take advantage of higher throughputs possible at higher frequencies. Improvements in the field are desired.

### SUMMARY

Embodiments relate to wireless communications, and more particularly to apparatuses, systems, and methods for a network-controlled repeater (NCR) to provide hybrid automatic repeat request (HARQ) acknowledgment/negative acknowledgment (ACK/NACK) to a base station.

In some embodiments, the NCR receives a control message from a base station over a control link, where the control message configures the NCR with parameters that may include resources for forwarding an uplink or downlink message.

In various embodiments, the downlink message is received from the base station over a backhaul link for forwarding to one or more user equipments (UEs), or the uplink message is received from a UE over an access link for forwarding to a base station.

It may be determined whether the received uplink or downlink message was received with a signal quality that exceeds a quality threshold. When the signal quality exceeds the quality threshold, the uplink or downlink message is transmitted to the base station or the UE, respectively.

In some embodiments, HARQ ACK/NACK feedback is provided to the base station by the NCR. The HARQ ACK/NACK feedback may be provided as separate HARQ messages to acknowledge whether or not the control message and the uplink/downlink message were successfully received. Alternatively, in some embodiments, joint HARQ feedback may be transmitted that provides ACK/NACK feedback for both the control message and the uplink/downlink message. In some embodiments, whether separate or joint HARQ feedback is implemented may be determined based on timing offsets of the control message and the uplink/downlink message.

In some embodiments, separate or joint HARQ feedback may be provided when the NCR receives multiple control messages from the base station.

This Summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

A better understanding of the present subject matter can be obtained when the following detailed description of various embodiments is considered in conjunction with the following drawings, in which:

FIG. 1A illustrates an example wireless communication system according to some embodiments.

FIG. 1B illustrates an example of a base station and an access point in communication with a user equipment (UE) device, according to some embodiments.

FIG. 1C illustrates an example wireless communication system including a network-controlled repeater (NCR), according to some embodiments.

FIG. 2 illustrates an example block diagram of a base station, according to some embodiments.

FIG. 3 illustrates an example block diagram of an NCR, according to some embodiments.

FIG. 4 illustrates an example block diagram of a UE, according to some embodiments.

FIG. 5 is a flowchart diagram illustrating a method for providing HARQ-ACK feedback by an NCR during downlink forwarding, according to some embodiments.

FIG. 6 is a flowchart diagram illustrating a method for providing HARQ-ACK feedback by an NCR during uplink forwarding, according to some embodiments.

FIG. 7 is a flowchart diagram illustrating a method for providing HARQ-ACK feedback by an NCR when receiving multiple control messages, according to some embodiments.

FIG. 8 is a communication flow diagram illustrating a method for providing separate HARQ-ACK feedback by an NCR during downlink forwarding, according to some embodiments.

FIG. 9 is a communication flow diagram illustrating a method for providing joint HARQ-ACK feedback by an NCR during downlink forwarding, according to some embodiments.

FIG. 10 is a communication flow diagram illustrating a method for providing separate HARQ-ACK feedback by an NCR during uplink forwarding, according to some embodiments.

FIG. 11 is a communication flow diagram illustrating a method for providing joint HARQ-ACK feedback by an NCR during uplink forwarding, according to some embodiments.

FIG. 12 is a communication flow diagram illustrating a method for providing separate HARQ-ACK feedback by an NCR for SCI via a physical downlink control channel (PDCCH) and SCI via a physical downlink shared channel (PDSCH), according to some embodiments.

FIG. 13 is a communication flow diagram illustrating a method for providing joint HARQ-ACK feedback by an NCR for SCI via a physical downlink control channel (PDCCH) and SCI via a physical downlink shared channel (PDSCH), according to some embodiments.

While the features described herein may be susceptible to various modifications and alternative forms, specific embodiments thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION

### Acronyms

Various acronyms are used throughout the present disclosure. Definitions of the most prominently used acronyms that may appear throughout the present disclosure are provided below:
3GPP: Third Generation Partnership Project
UE: User Equipment
RF: Radio Frequency
BS: Base Station
DL: Downlink
UL: Uplink
LTE: Long Term Evolution
NR: New Radio
NCR: Network Controlled Repeater
DAS: Distributed Antenna System
5GS: 5G System
5GMM: 5GS Mobility Management
5GC/5GCN: 5G Core Network
SIM: Subscriber Identity Module
eSIM: Embedded Subscriber Identity Module
IE: Information Element
CE: Control Element
MAC: Medium Access Control
SSB: Synchronization Signal Block
CSI-RS: Channel State Information Reference Signal
PDCCH: Physical Downlink Control Channel
PDSCH: Physical Downlink Shared Channel
PUCCH: Physical Uplink Control Channel
PUSCH: Physical Uplink Shared Channel
RRC: Radio Resource Control
RRM: Radio Resource Management
CORESET: Control Resource Set
TCI: Transmission Configuration Indication
DCI: Downlink Control Information
SCI: Sidelink Control Information
UCI: Uplink Control Information

### Terms

The following is a glossary of terms used in this disclosure:

Memory Medium—Any of various types of non-transitory memory devices or storage devices. The term “memory medium” is intended to include an installation medium, e.g., a CD-ROM, floppy disks, or tape device; a computer system memory or random-access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. The memory medium may include other types of non-transitory memory as well or combinations thereof. In addition, the memory medium may be located in a first computer system in which the programs are executed, or may be located in a second different computer system which connects to the first computer system over a network, such as the Internet. In the latter instance, the second computer system may provide program instructions to the first computer for execution. The term “memory medium” may include two or more memory mediums which may reside in different locations, e.g., in different computer systems that are connected over a network. The memory medium may store program instructions (e.g., embodied as computer programs) that may be executed by one or more processors.

Carrier Medium—a memory medium as described above, as well as a physical transmission medium, such as a bus, network, and/or other physical transmission medium that conveys signals such as electrical, electromagnetic, or digital signals.

Programmable Hardware Element—includes various hardware devices comprising multiple programmable function blocks connected via a programmable interconnect. Examples include FPGAs (Field Programmable Gate Arrays), PLDs (Programmable Logic Devices), FPOAs (Field Programmable Object Arrays), and CPLDs (Complex PLDs). The programmable function blocks may range from fine grained (combinatorial logic or look up tables) to coarse grained (arithmetic logic units or processor cores). A programmable hardware element may also be referred to as “reconfigurable logic”.

Computer System (or Computer)—any of various types of computing or processing systems, including a personal computer system (PC), mainframe computer system, workstation, network appliance, Internet appliance, personal digital assistant (PDA), television system, grid computing system, or other device or combinations of devices. In general, the term “computer system” can be broadly defined to encompass any device (or combination of devices) having at least one processor that executes instructions from a memory medium.

User Equipment (UE) (or “UE Device”)—any of various types of computer systems devices which are mobile or portable and which performs wireless communications. Examples of UE devices include mobile telephones or smart phones (e.g., iPhone™, Android™_based phones), portable gaming devices (e.g., Nintendo DS™, PlayStation Portable™, Gameboy Advance™, iPhone™), laptops, wearable devices (e.g., smart watch, smart glasses), PDAs, portable Internet devices, music players, data storage devices, other handheld devices, unmanned aerial vehicles (UAVs) (e.g., drones), UAV controllers (UACs), and so forth. In general, the term “UE” or “UE device” can be broadly defined to encompass any electronic, computing, and/or telecommunications device (or combination of devices) which is easily transported by a user and capable of wireless communication.

Base Station—The term “Base Station” has the full breadth of its ordinary meaning, and at least includes a wireless communication station installed at a fixed location and used to communicate as part of a wireless telephone system or radio system.

Processing Element (or Processor)—refers to various elements or combinations of elements that are capable of performing a function in a device, such as a user equipment or a cellular network device. Processing elements may include, for example: processors and associated memory, portions or circuits of individual processor cores, entire processor cores, processor arrays, circuits such as an ASIC (Application Specific Integrated Circuit), programmable hardware elements such as a field programmable gate array (FPGA), as well any of various combinations of the above.

Channel—a medium used to convey information from a sender (transmitter) to a receiver. It should be noted that since characteristics of the term “channel” may differ according to different wireless protocols, the term “channel” as used herein may be considered as being used in a manner that is consistent with the standard of the type of device with reference to which the term is used. In some standards, channel widths may be variable (e.g., depending on device capability, band conditions, etc.). For example, LTE may support scalable channel bandwidths from 1.4 MHz to 20 MHz. In contrast, WLAN channels may be 22 MHz wide while Bluetooth channels may be 1 Mhz wide. Other protocols and standards may include different definitions of channels. Furthermore, some standards may define and use multiple types of channels, e.g., different channels for uplink or downlink and/or different channels for different uses such as data, control information, etc.

Band—The term “band” has the full breadth of its ordinary meaning, and at least includes a section of spectrum (e.g., radio frequency spectrum) in which channels are used or set aside for the same purpose.

Wi-Fi—The term “Wi-Fi” (or WiFi) has the full breadth of its ordinary meaning, and at least includes a wireless communication network or RAT that is serviced by wireless LAN (WLAN) access points and which provides connectivity through these access points to the Internet. Most modern Wi-Fi networks (or WLAN networks) are based on IEEE 802.11 standards and are marketed under the name “Wi-Fi”. A Wi-Fi (WLAN) network is different from a cellular network.

3GPP Access—refers to accesses (e.g., radio access technologies) that are specified by 3GPP standards. These accesses include, but are not limited to, GSM/GPRS, LTE, LTE-A, and/or 5G NR. In general, 3GPP access refers to various types of cellular access technologies.

Non-3GPP Access—refers any accesses (e.g., radio access technologies) that are not specified by 3GPP standards. These accesses include, but are not limited to, WiMAX, CDMA2000, Wi-Fi, WLAN, and/or fixed networks. Non-3GPP accesses may be split into two categories, “trusted” and “untrusted”: Trusted non-3GPP accesses can interact directly with an evolved packet core (EPC) and/or a 5G core (5GC) whereas untrusted non-3GPP accesses interwork with the EPC/5GC via a network entity, such as an Evolved Packet Data Gateway and/or a 5G NR gateway. In general, non-3GPP access refers to various types on non-cellular access technologies.

Automatically—refers to an action or operation performed by a computer system (e.g., software executed by the computer system) or device (e.g., circuitry, programmable hardware elements, ASICs, etc.), without user input directly specifying or performing the action or operation. Thus, the term “automatically” is in contrast to an operation being manually performed or specified by the user, where the user provides input to directly perform the operation. An automatic procedure may be initiated by input provided by the user, but the subsequent actions that are performed “automatically” are not specified by the user, i.e., are not performed “manually”, where the user specifies each action to perform. For example, a user filling out an electronic form by selecting each field and providing input specifying information (e.g., by typing information, selecting check boxes, radio selections, etc.) is filling out the form manually, even though the computer system must update the form in response to the user actions. The form may be automatically filled out by the computer system where the computer system (e.g., software executing on the computer system) analyzes the fields of the form and fills in the form without any user input specifying the answers to the fields. As indicated above, the user may invoke the automatic filling of the form, but is not involved in the actual filling of the form (e.g., the user is not manually specifying answers to fields but rather they are being automatically completed). The present specification provides various examples of operations being automatically performed in response to actions the user has taken.

Approximately—refers to a value that is almost correct or exact. For example, approximately may refer to a value that is within 1 to 10 percent of the exact (or desired) value. It should be noted, however, that the actual threshold value (or tolerance) may be application dependent. For example, in some embodiments, “approximately” may mean within 0.1% of some specified or desired value, while in various other embodiments, the threshold may be, for example, 2%, 3%, 5%, and so forth, as desired or as required by the particular application.

Concurrent—refers to parallel execution or performance, where tasks, processes, or programs are performed in an at least partially overlapping manner. For example, concurrency may be implemented using “strong” or strict parallelism, where tasks are performed (at least partially) in parallel on respective computational elements, or using “weak parallelism”, where the tasks are performed in an interleaved manner, e.g., by time multiplexing of execution threads.

Various components may be described as “configured to” perform a task or tasks. In such contexts, “configured to” is a broad recitation generally meaning “having structure that” performs the task or tasks during operation. As such, the component can be configured to perform the task even when the component is not currently performing that task (e.g., a set of electrical conductors may be configured to electrically connect a module to another module, even when the two modules are not connected). In some contexts, “configured to” may be a broad recitation of structure generally meaning “having circuitry that” performs the task or tasks during operation. As such, the component can be configured to perform the task even when the component is not currently on. In general, the circuitry that forms the structure corresponding to “configured to” may include hardware circuits.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112(f) interpretation for that component.

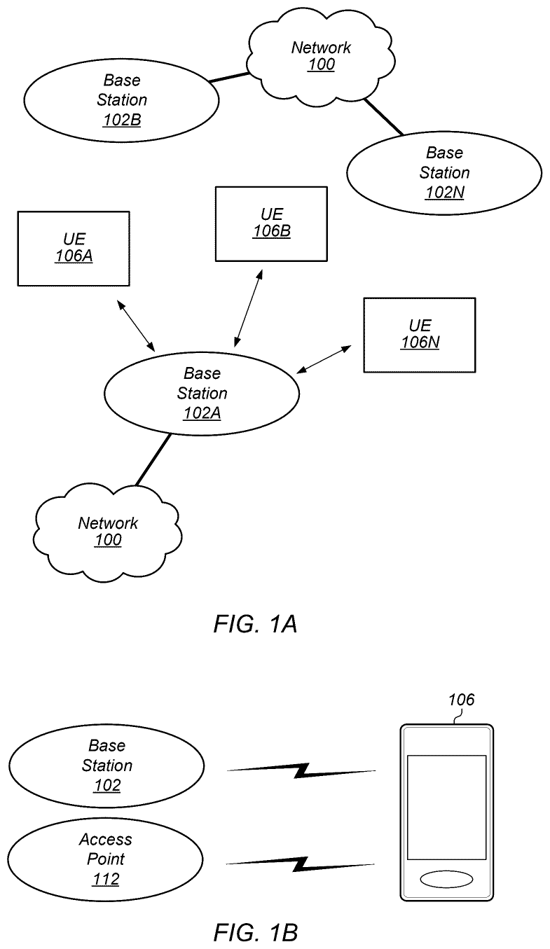

### FIGS. 1A-1C: Communication Systems

FIG. 1A illustrates a simplified example wireless communication system, according to some embodiments. It is noted that the system of FIG. 1A is merely one example of a possible system, and that features of this disclosure may be implemented in any of various systems, as desired.

As shown, the example wireless communication system includes a base station 102A which communicates over a transmission medium with one or more user devices 106A, 106B, etc., through 106N. Each of the user devices may be referred to herein as a “user equipment” (UE). Thus, the user devices 106 are referred to as UEs or UE devices.

The base station (BS) 102A may be a base transceiver station (BTS) or cell site (a “cellular base station”) and may include hardware that enables wireless communication with the UEs 106A through 106N.

The communication area (or coverage area) of the base station may be referred to as a “cell.” The base station 102A and the UEs 106 may be configured to communicate over the transmission medium using any of various radio access technologies (RATs), also referred to as wireless communication technologies, or telecommunication standards, such as GSM, UMTS (associated with, for example, WCDMA or TD-SCDMA air interfaces), LTE, LTE-Advanced (LTE-A), 5G new radio (5G NR), HSPA, 3GPP2 CDMA2000 (e.g., 1×RTT, 1×EV-DO, HRPD, eHRPD), etc. Note that if the base station 102A is implemented in the context of LTE, it may alternately be referred to as an ‘eNodeB’ or ‘eNB’. Note that if the base station 102A is implemented in the context of 5G NR, it may alternately be referred to as ‘gNodeB’ or ‘gNB’.

As shown, the base station 102A may also be equipped to communicate with a network 100 (e.g., a core network of a cellular service provider, a telecommunication network such as a public switched telephone network (PSTN), and/or the Internet, among various possibilities). Thus, the base station 102A may facilitate communication between the user devices and/or between the user devices and the network 100. In particular, the cellular base station 102A may provide UEs 106 with various telecommunication capabilities, such as voice, SMS and/or data services.

Base station 102A and other similar base stations (such as base stations 102B . . . 102N) operating according to the same or a different cellular communication standard may thus be provided as a network of cells, which may provide continuous or nearly continuous overlapping service to UEs 106A-N and similar devices over a geographic area via one or more cellular communication standards.

Thus, while base station 102A may act as a “serving cell” for UEs 106A-N as illustrated in FIG. 1, each UE 106 may also be capable of receiving signals from (and possibly within communication range of) one or more other cells (which might be provided by base stations 102B-N and/or any other base stations), which may be referred to as “neighboring cells”. Such cells may also be capable of facilitating communication between user devices and/or between user devices and the network 100. Such cells may include “macro” cells, “micro” cells, “pico” cells, and/or cells which provide any of various other granularities of service area size. For example, base stations 102A-B illustrated in FIG. 1 might be macro cells, while base station 102N might be a micro cell. Other configurations are also possible.

In some embodiments, base station 102A may be a next generation base station, e.g., a 5G New Radio (5G NR) base station, or “gNB”. In some embodiments, a gNB may be connected to a legacy evolved packet core (EPC) network and/or to a NR core (NRC) network. In addition, a gNB cell may include one or more transition and reception points (TRPs). In addition, a UE capable of operating according to 5G NR may be connected to one or more TRPs within one or more gNBs.

Note that a UE 106 may be capable of communicating using multiple wireless communication standards. For example, the UE 106 may be configured to communicate using a wireless networking (e.g., Wi-Fi) and/or peer-to-peer wireless communication protocol (e.g., Bluetooth, Wi-Fi peer-to-peer, etc.) in addition to at least one cellular communication protocol (e.g., GSM, UMTS (associated with, for example, WCDMA or TD-SCDMA air interfaces), LTE, LTE-A, 5G NR, HSPA, 3GPP2 CDMA2000 (e.g., 1×RTT, 1×EV-DO, HRPD, eHRPD), etc.). The UE 106 may also or alternatively be configured to communicate using one or more global navigational satellite systems (GNSS, e.g., GPS or GLONASS), one or more mobile television broadcasting standards (e.g., ATSC-M/H or DVB-H), and/or any other wireless communication protocol, if desired. Other combinations of wireless communication standards (including more than two wireless communication standards) are also possible.

FIG. 1B illustrates user equipment 106 (e.g., one of the devices 106A through 106N) in communication with a base station 102 and an access point 112, according to some embodiments. The UE 106 may be a device with both cellular communication capability and non-cellular communication capability (e.g., Bluetooth, Wi-Fi, and so forth) such as a mobile phone, a hand-held device, a computer or a tablet, or virtually any type of wireless device.

The UE 106 may include a processor that is configured to execute program instructions stored in memory. The UE 106 may perform any of the method embodiments described herein by executing such stored instructions. Alternatively, or in addition, the UE 106 may include a programmable hardware element such as an FPGA (field-programmable gate array) that is configured to perform any of the method embodiments described herein, or any portion of any of the method embodiments described herein.

The UE 106 may include one or more antennas for communicating using one or more wireless communication protocols or technologies. In some embodiments, the UE 106 may be configured to communicate using, for example, CDMA2000 (1×RTT/1×EV-DO/HRPD/eHRPD), LTE/LTE-Advanced, or 5G NR using a single shared radio and/or GSM, LTE, LTE-Advanced, or 5G NR using the single shared radio. The shared radio may couple to a single antenna, or may couple to multiple antennas (e.g., for MIMO) for performing wireless communications. In general, a radio may include any combination of a baseband processor, analog RF signal processing circuitry (e.g., including filters, mixers, oscillators, amplifiers, etc.), or digital processing circuitry (e.g., for digital modulation as well as other digital processing). Similarly, the radio may implement one or more receive and transmit chains using the aforementioned hardware. For example, the UE 106 may share one or more parts of a receive and/or transmit chain between multiple wireless communication technologies, such as those discussed above.

In some embodiments, the UE 106 may include separate transmit and/or receive chains (e.g., including separate antennas and other radio components) for each wireless communication protocol with which it is configured to communicate. As a further possibility, the UE 106 may include one or more radios which are shared between multiple wireless communication protocols, and one or more radios which are used exclusively by a single wireless communication protocol. For example, the UE 106 might include a shared radio for communicating using either of LTE or 5G NR (or LTE or 1×RTT or LTE or GSM), and separate radios for communicating using each of Wi-Fi and Bluetooth. Other configurations are also possible.

FIG. 1C illustrates a communication scenario where a network-controlled repeater (NCR) facilitates communications between a base station 102A and one or more UEs 102A-106N. In some deployments, a base station may be able to effectively communicate with a subset of its serviced UEs (e.g., UE 106A), but may be out of effective range of one or more other UEs (e.g., UE 106B). In this case, the network may direct an NCR to forward messages between the UE 106B and the base station. As described in greater detail below, the NCR may receive sidelink control information from the base station to configure the forwarding communications.

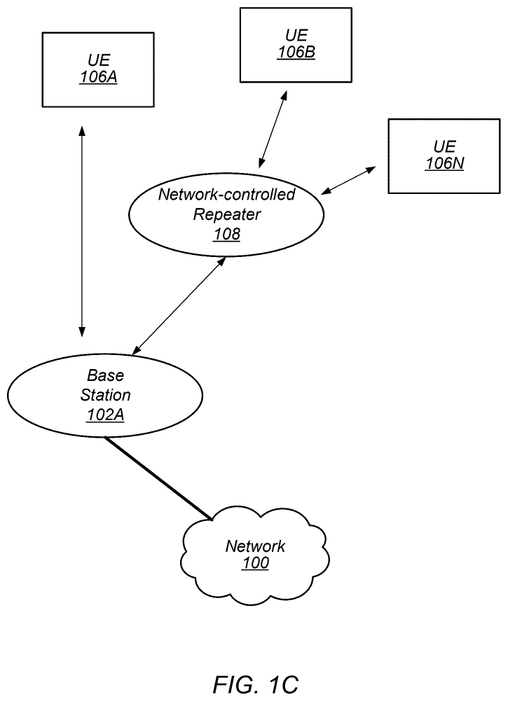

### FIG. 2: Block Diagram of a Base Station

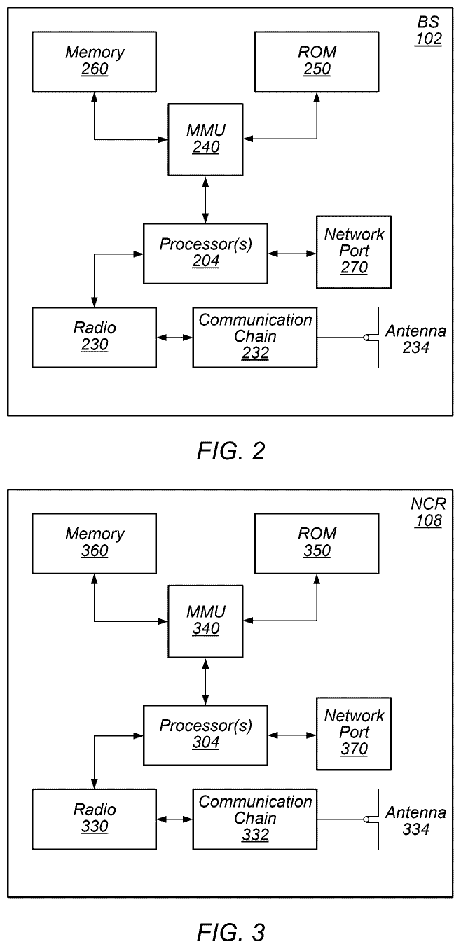

FIG. 2 illustrates an example block diagram of a base station 102, according to some embodiments. It is noted that the base station of FIG. 3 is merely one example of a possible base station. As shown, the base station 102 may include processor(s) 204 which may execute program instructions for the base station 102. The processor(s) 204 may also be coupled to memory management unit (MMU) 240, which may be configured to receive addresses from the processor(s) 204 and translate those addresses to locations in memory (e.g., memory 260 and read only memory (ROM) 250) or to other circuits or devices.

The base station 102 may include at least one network port 270. The network port 270 may be configured to couple to a telephone network and provide a plurality of devices, such as UE devices 106, access to the telephone network as described above in FIGS. 1 and 2.

The network port 270 (or an additional network port) may also or alternatively be configured to couple to a cellular network, e.g., a core network of a cellular service provider. The core network may provide mobility related services and/or other services to a plurality of devices, such as UE devices 106. In some cases, the network port 270 may couple to a telephone network via the core network, and/or the core network may provide a telephone network (e.g., among other UE devices serviced by the cellular service provider).

In some embodiments, base station 102 may be a next generation base station, e.g., a 5G New Radio (5G NR) base station, or “gNB”. In such embodiments, base station 102 may be connected to a legacy evolved packet core (EPC) network and/or to a NR core (NRC) network. In addition, base station 102 may be considered a 5G NR cell and may include one or more transition and reception points (TRPs). In addition, a UE capable of operating according to 5G NR may be connected to one or more TRPs within one or more gNBs.

The base station 102 may include at least one antenna 234, and possibly multiple antennas. The at least one antenna 234 may be configured to operate as a wireless transceiver and may be further configured to communicate with UE devices 106 via radio 230. The antenna 234 communicates with the radio 230 via communication chain 232. Communication chain 232 may be a receive chain, a transmit chain or both. The radio 230 may be configured to communicate via various wireless communication standards, including, but not limited to, 5G NR, LTE, LTE-A, GSM, UMTS, CDMA2000, Wi-Fi, etc.

The base station 102 may be configured to communicate wirelessly using multiple wireless communication standards. In some instances, the base station 102 may include multiple radios, which may enable the base station 102 to communicate according to multiple wireless communication technologies. For example, as one possibility, the base station 102 may include an LTE radio for performing communication according to LTE as well as a 5G NR radio for performing communication according to 5G NR. In such a case, the base station 102 may be capable of operating as both an LTE base station and a 5G NR base station. As another possibility, the base station 102 may include a multi-mode radio which is capable of performing communications according to any of multiple wireless communication technologies (e.g., 5G NR and Wi-Fi, LTE and Wi-Fi, LTE and UMTS, LTE and CDMA2000, UMTS and GSM, etc.).

As described further subsequently herein, the BS 102 may include hardware and software components for implementing or supporting implementation of features described herein. The processor 204 of the base station 102 may be configured to implement or support implementation of part or all of the methods described herein, e.g., by executing program instructions stored on a memory medium (e.g., a non-transitory computer-readable memory medium). Alternatively, the processor 204 may be configured as a programmable hardware element, such as an FPGA (Field Programmable Gate Array), or as an ASIC (Application Specific Integrated Circuit), or a combination thereof. Alternatively (or in addition) the processor 204 of the BS 102, in conjunction with one or more of the other components 230, 232, 234, 240, 250, 260, 270 may be configured to implement or support implementation of part or all of the features described herein.

In addition, as described herein, processor(s) 204 may be comprised of one or more processing elements. In other words, one or more processing elements may be included in processor(s) 204. Thus, processor(s) 204 may include one or more integrated circuits (ICs) that are configured to perform the functions of processor(s) 204. In addition, each integrated circuit may include circuitry (e.g., first circuitry, second circuitry, etc.) configured to perform the functions of processor(s) 204.

Further, as described herein, radio 230 may be comprised of one or more processing elements. In other words, one or more processing elements may be included in radio 230. Thus, radio 230 may include one or more integrated circuits (ICs) that are configured to perform the functions of radio 230. In addition, each integrated circuit may include circuitry (e.g., first circuitry, second circuitry, etc.) configured to perform the functions of radio 230.

### FIG. 3: Block Diagram of an NCR

FIG. 3 illustrates an example block diagram of a network-controlled repeater (NCR), according to some embodiments. It is noted that the NCR of FIG. 3 is merely one example of a possible NCR. As shown, the NCR 108 may include processor(s) 304 which may execute program instructions for the NCR 108. The processor(s) 304 may also be coupled to memory management unit (MMU) 340, which may be configured to receive addresses from the processor(s) 304 and translate those addresses to locations in memory (e.g., memory 360 and read only memory (ROM) 350) or to other circuits or devices.

The NCR 108 may include at least one network port 370. The network port 370 may be configured to couple to a base station, such as a gNB, and forward communications between the base station and a plurality of devices, such as UE devices 106, as described above in FIGS. 1 and 2.

In some embodiments, NCR 108 may communicate using a next generation cellular technology, e.g., a 5G New Radio (5G NR) radio access technology (RAT). The NCR 108 may include at least one antenna 334, and possibly multiple antennas. The at least one antenna 334 may be configured to operate as a wireless transceiver and may be further configured to communicate with a base station 102 and UE devices 106 via radio 330. The antenna 334 communicates with the radio 330 via communication chain 332. Communication chain 332 may be a receive chain, a transmit chain or both. The radio 330 may be configured to communicate via various wireless communication standards, including, but not limited to, 5G NR, LTE, LTE-A, GSM, UMTS, CDMA2000, Wi-Fi, etc.

The NCR 108 may be configured to communicate wirelessly using multiple wireless communication standards. In some instances, the NCR 108 may include multiple radios, which may enable the NCR 108 to communicate according to multiple wireless communication technologies. For example, as one possibility, the NCR 108 may include an LTE radio for performing communication according to LTE as well as a 5G NR radio for performing communication according to 5G NR. In such a case, the NCR 108 may be capable of communicating with both an LTE base station, a 5G NR base station, and potentially a 6th generation base station. As another possibility, the NCR 108 may include a multi-mode radio which is capable of performing communications according to any of multiple wireless communication technologies (e.g., 5G NR and Wi-Fi, LTE and Wi-Fi, LTE and UMTS, LTE and CDMA2000, UMTS and GSM, etc.).

As described further subsequently herein, the NCR 108 may include hardware and software components for implementing or supporting implementation of features described herein. The processor 304 of the NCR 108 may be configured to implement or support implementation of part or all of the methods described herein, e.g., by executing program instructions stored on a memory medium (e.g., a non-transitory computer-readable memory medium). Alternatively, the processor 304 may be configured as a programmable hardware element, such as an FPGA (Field Programmable Gate Array), or as an ASIC (Application Specific Integrated Circuit), or a combination thereof. Alternatively (or in addition) the processor 304 of the NCR 108, in conjunction with one or more of the other components 330, 332, 334, 340, 350, 360, 370 may be configured to implement or support implementation of part or all of the features described herein.

In addition, as described herein, processor(s) 304 may be comprised of one or more processing elements. In other words, one or more processing elements may be included in processor(s) 304. Thus, processor(s) 304 may include one or more integrated circuits (ICs) that are configured to perform the functions of processor(s) 204. In addition, each integrated circuit may include circuitry (e.g., first circuitry, second circuitry, etc.) configured to perform the functions of processor(s) 304.

Further, as described herein, radio 330 may be comprised of one or more processing elements. In other words, one or more processing elements may be included in radio 330. Thus, radio 330 may include one or more integrated circuits (ICs) that are configured to perform the functions of radio 330. In addition, each integrated circuit may include circuitry (e.g., first circuitry, second circuitry, etc.) configured to perform the functions of radio 330.

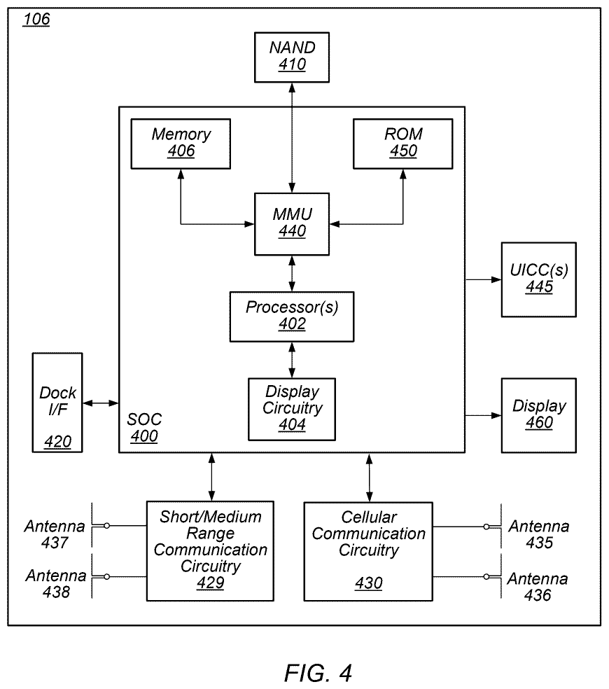

### FIG. 4: Block Diagram of a UE

FIG. 4 illustrates an example simplified block diagram of a UE 106, according to some embodiments. It is noted that the block diagram of the UE of FIG. 4 is only one example of a possible UE. According to embodiments, UE 106 may be a user equipment (UE) device, a mobile device or mobile station, a wireless device or wireless station, a desktop computer or computing device, a mobile computing device (e.g., a laptop, notebook, or portable computing device), a tablet, an unmanned aerial vehicle (UAV), a UAV controller (UAC) and/or a combination of devices, among other devices. As shown, the UE 106 may include a set of components 400 configured to perform core functions. For example, this set of components may be implemented as a system on chip (SOC), which may include portions for various purposes. Alternatively, this set of components 400 may be implemented as separate components or groups of components for the various purposes. The set of components 400 may be coupled (e.g., communicatively; directly or indirectly) to various other circuits of the UE 106.

For example, the UE 106 may include various types of memory (e.g., including NAND flash 410), an input/output interface such as connector I/F 420 (e.g., for connecting to a computer system; dock; charging station; input devices, such as a microphone, camera, keyboard; output devices, such as speakers; etc.), the display 460, which may be integrated with or external to the UE 106, and cellular communication circuitry 430 such as for 5G NR, LTE, GSM, etc., and short to medium range wireless communication circuitry 429 (e.g., Bluetooth™ and WLAN circuitry). In some embodiments, UE 106 may include wired communication circuitry (not shown), such as a network interface card, e.g., for Ethernet.

The cellular communication circuitry 430 may couple (e.g., communicatively; directly or indirectly) to one or more antennas, such as antennas 435 and 436 as shown. The short to medium range wireless communication circuitry 429 may also couple (e.g., communicatively; directly or indirectly) to one or more antennas, such as antennas 437 and 438 as shown. Alternatively, the short to medium range wireless communication circuitry 429 may couple (e.g., communicatively; directly or indirectly) to the antennas 435 and 436 in addition to, or instead of, coupling (e.g., communicatively; directly or indirectly) to the antennas 437 and 438. The short to medium range wireless communication circuitry 429 and/or cellular communication circuitry 430 may include multiple receive chains and/or multiple transmit chains for receiving and/or transmitting multiple spatial streams, such as in a multiple-input multiple output (MIMO) configuration.

In some embodiments, as further described below, cellular communication circuitry 430 may include dedicated receive chains (including and/or coupled to, e.g., communicatively; directly or indirectly. dedicated processors and/or radios) for multiple RATs (e.g., a first receive chain for LTE and a second receive chain for 5G NR). In addition, in some embodiments, cellular communication circuitry 430 may include a single transmit chain that may be switched between radios dedicated to specific RATs. For example, a first radio may be dedicated to a first RAT, e.g., LTE, and may be in communication with a dedicated receive chain and a transmit chain shared with an additional radio, e.g., a second radio that may be dedicated to a second RAT, e.g., 5G NR, and may be in communication with a dedicated receive chain and the shared transmit chain. The UE 106 may be configured to communicate with one or more base stations 102 and network-controlled repeaters 108.

The UE 106 may also include and/or be configured for use with one or more user interface elements. The user interface elements may include any of various elements, such as display 460 (which may be a touchscreen display), a keyboard (which may be a discrete keyboard or may be implemented as part of a touchscreen display), a mouse, a microphone and/or speakers, one or more cameras, one or more buttons, and/or any of various other elements capable of providing information to a user and/or receiving or interpreting user input.

The UE 106 may further include one or more smart cards 445 that include SIM (Subscriber Identity Module) functionality, such as one or more UICC(s) (Universal Integrated Circuit Card(s)) cards 445. Note that the term “SIM” or “SIM entity” is intended to include any of various types of SIM implementations or SIM functionality, such as the one or more UICC(s) cards 445, one or more eUICCs, one or more eSIMs, either removable or embedded, etc. In some embodiments, the UE 106 may include at least two SIMs. Each SIM may execute one or more SIM applications and/or otherwise implement SIM functionality. Thus, each SIM may be a single smart card that may be embedded, e.g., may be soldered onto a circuit board in the UE 106, or each SIM 410 may be implemented as a removable smart card. Thus, the SIM(s) may be one or more removable smart cards (such as UICC cards, which are sometimes referred to as “SIM cards”), and/or the SIMs 410 may be one or more embedded cards (such as embedded UICCs (eUICCs), which are sometimes referred to as “eSIMs” or “eSIM cards”). In some embodiments (such as when the SIM(s) include an eUICC), one or more of the SIM(s) may implement embedded SIM (eSIM) functionality; in such an embodiment, a single one of the SIM(s) may execute multiple SIM applications. Each of the SIMs may include components such as a processor and/or a memory; instructions for performing SIM/eSIM functionality may be stored in the memory and executed by the processor. In some embodiments, the UE 106 may include a combination of removable smart cards and fixed/non-removable smart cards (such as one or more eUICC cards that implement eSIM functionality), as desired. For example, the UE 106 may comprise two embedded SIMs, two removable SIMs, or a combination of one embedded SIMs and one removable SIMs. Various other SIM configurations are also contemplated.

As noted above, in some embodiments, the UE 106 may include two or more SIMs. The inclusion of two or more SIMs in the UE 106 may allow the UE 106 to support two different telephone numbers and may allow the UE 106 to communicate on corresponding two or more respective networks. For example, a first SIM may support a first RAT such as LTE, and a second SIM 410 support a second RAT such as 5G NR. Other implementations and RATs are of course possible. In some embodiments, when the UE 106 comprises two SIMs, the UE 106 may support Dual SIM Dual Active (DSDA) functionality. The DSDA functionality may allow the UE 106 to be simultaneously connected to two networks (and use two different RATs) at the same time, or to simultaneously maintain two connections supported by two different SIMs using the same or different RATs on the same or different networks. The DSDA functionality may also allow the UE 106 to simultaneously receive voice calls or data traffic on either phone number. In certain embodiments the voice call may be a packet switched communication. In other words, the voice call may be received using voice over LTE (VoLTE) technology and/or voice over NR (VoNR) technology. In some embodiments, the UE 106 may support Dual SIM Dual Standby (DSDS) functionality. The DSDS functionality may allow either of the two SIMs in the UE 106 to be on standby waiting for a voice call and/or data connection. In DSDS, when a call/data is established on one SIM, the other SIM is no longer active. In some embodiments, DSDx functionality (either DSDA or DSDS functionality) may be implemented with a single SIM (e.g., a eUICC) that executes multiple SIM applications for different carriers and/or RATs.

As shown, the SOC 400 may include processor(s) 402, which may execute program instructions for the UE 106 and display circuitry 404, which may perform graphics processing and provide display signals to the display 460. The processor(s) 402 may also be coupled to memory management unit (MMU) 440, which may be configured to receive addresses from the processor(s) 402 and translate those addresses to locations in memory (e.g., memory 406, read only memory (ROM) 450, NAND flash memory 410) and/or to other circuits or devices, such as the display circuitry 404, short to medium range wireless communication circuitry 429, cellular communication circuitry 430, connector I/F 420, and/or display 460. The MMU 440 may be configured to perform memory protection and page table translation or set up. In some embodiments, the MMU 440 may be included as a portion of the processor(s) 402.

As noted above, the UE 106 may be configured to communicate using wireless and/or wired communication circuitry. The UE 106 may be configured to perform methods for revocation and/or modification of user consent in MEC, e.g., in 5G NR systems and beyond, as further described herein.

As described herein, the processor 402 of the UE 106 may be configured to implement part or all of the features described herein, e.g., by executing program instructions stored on a memory medium (e.g., a non-transitory computer-readable memory medium). Alternatively (or in addition), processor 402 may be configured as a programmable hardware element, such as an FPGA (Field Programmable Gate Array), or as an ASIC (Application Specific Integrated Circuit). Alternatively (or in addition) the processor 402 of the UE 106, in conjunction with one or more of the other components 400, 404, 406, 410, 420, 429, 430, 440, 445, 450, 460 may be configured to implement part or all of the features described herein.

In addition, as described herein, processor 402 may include one or more processing elements. Thus, processor 402 may include one or more integrated circuits (ICs) that are configured to perform the functions of processor 402. In addition, each integrated circuit may include circuitry (e.g., first circuitry, second circuitry, etc.) configured to perform the functions of processor(s) 402.

Further, as described herein, cellular communication circuitry 430 and short to medium range wireless communication circuitry 429 may each include one or more processing elements. In other words, one or more processing elements may be included in cellular communication circuitry 430 and, similarly, one or more processing elements may be included in short to medium range wireless communication circuitry 429. Thus, cellular communication circuitry 430 may include one or more integrated circuits (ICs) that are configured to perform the functions of cellular communication circuitry 430. In addition, each integrated circuit may include circuitry (e.g., first circuitry, second circuitry, etc.) configured to perform the functions of cellular communication circuitry 430. Similarly, the short to medium range wireless communication circuitry 429 may include one or more ICs that are configured to perform the functions of short to medium range wireless communication circuitry 429. In addition, each integrated circuit may include circuitry (e.g., first circuitry, second circuitry, etc.) configured to perform the functions of short to medium range wireless communication circuitry 429.

### Network Controlled Repeaters

It is expected that in upcoming cellular deployments (e.g., 3GPP NR Rel-18), network-controlled repeaters (NCRs) may be utilized to improve the downlink (DL) and/or uplink (UL) coverage by deploying spatially directive repeaters in regions where the gNBs and/or transmit receive points (TRPs) are not able to provide reliable coverage. Current implementations already deploy radio frequency (RF) repeaters that receive (without decoding), amplify and forward transmissions between base stations and UEs. However, these repeaters are not capable of beam forming in specified directions. With network-controlled repeaters, a motivation is to introduce the capability for repeaters to be controllable by the network in terms of spatial directivity. Specifically for higher frequency ranges (FRs), simply forwarding at the repeater without any specific beam direction may not be very beneficial. Therefore, repeaters that may be controlled by the network to direct the transmit and/or receive beams at the repeater may further improve coverage, in especially frequency range 2 (FR2), or above 24 GHz.

To effectively and dynamically implement beamforming, the repeaters may receive control information from the network to be instructed when and where to direct their Tx and Rx spatial filters (beams). Effective deployment of NCRs may involve a variety of types of side control information that is exchanged between the gNB and the NCR, potentially including but now limited to beamforming information, timing information to align transmission and/or reception boundaries of the NCR, information related to an UL-DL time-division duplex (TDD) configuration, ON-OFF information for efficient interference management and improved energy efficiency, and power control information for efficient interference management, among other possibilities. In various embodiments, this sidelink control information may be communicated through a combination of Layer 1 (L1) and/or Layer 2 (L2) signaling.

For example, an NCR providing uplink control information (UCI) that includes HARQ-ACK feedback may establish configurations from radio resource control (RRC), open application model (OAM), or it may be hard-coded, in various embodiments. These configurations may include configurations of the physical (PHY) channels to carry the L1/L2 signaling, including configurations for receiving PDCCH and/or PDSCH messaging, and transmitting PUCCH and/or PUSCH messaging. The L1/L2 signaling configurations may include configurations for downlink control information (DCI), sidelink control information (SCI), UCI, and/or medium access control (MAC) control elements (CEs), in various embodiments.

This additional messaging between the NCR and the network may be associated with additional HARQ-ACK feedback at the NCR so that the network can be informed whether the NCR has successfully received and decoded the control messaging. In these deployments, issues may arise where it is not known to a gNB whether reception or decoding errors occurred at the NCR or at the UE. For example, an NCR may typically set up both a control link (for communicating control information) and a backhaul link (for communicating information to be forwarded to the UE) for communications between the NCR and the gNB, and an access link for communications with the UE. If the gNB relies only on HARQ-ACK feedback from the UE (where the feedback is in reference to PDSCH transmissions), then the gNB may not correctly determine whether the issue is with one or both of the backhaul/control link and/or the access link. For example, if the NCR is configured to receive and forward a PDSCH transmission from the gNB to the UE, but the NCR did not even receive the PDSCH from the gNB (for example, if the signal strength is below a threshold on the configured Rx beam), then the UE may not receive the scheduled PDSCH and it may report a NACK back to gNB. In this case, the gNB may perform a HARQ retransmission, assuming the decoding error occurred at the UE (whereas the error actually occurred at the NCR). To address these and other concerns, embodiments herein present feedback mechanisms to assist the network in determining whether a transmission issue may be occurring in the backhaul/control link and/or the access link.

In various embodiments, the NCR may be configured by the network to report HARQ-ACK feedback to a gNB responsive to receiving side control information from the gNB via a control link, a downlink channel signal from the gNB via a backhaul link for forwarding to one or more UEs via an access link, and/or an uplink channel signal from the one or more UEs via the access link for forwarding to the gNB via the backhaul link. In these embodiments, the relevant HARQ-ACK feedback may be transmitted on a physical channel (for example, the PUSCH and/or PUCCH) from the NCR to the gNB via the control link.

In various embodiments, a value of 1 or 0 in the HARQ-ACK feedback may variously indicate whether a particular message was received at all, was received with a signal strength above a quality threshold, and/or was decoded successfully. Providing HARQ-ACK feedback to indicate that the signal strength of a transmission was below a quality threshold may be beneficial by assisting the network in determining link quality.

Additionally or alternatively, in some embodiments the NCR may refrain from transmitting HARQ-ACK feedback to indicate whether a transmission was successfully received. For example, in some embodiments HARQ-ACK feedback is sent when either of a ACK or a negative acknowledgment (NACK) is to be reported by the NCR to gNB. When the gNB doesn't receive either NACK or ACK, it may assume that the NCR was not able to receive configured/scheduled transmission and may consider it as a NACK.

In some embodiments, the NCR may be individually configured to report feedback for each of the control information and the downlink information (i.e., the information to be forwarded to a UE). For example, it may be configured to report feedback only for the control information and not for the downlink information or vice versa, or it may be configured to report feedback for both (e.g., either separately or in a single joint feedback transmission).

In some embodiments, the NCR may be configured to provide HARQ-ACK feedback corresponding to forwarding channels that are dynamically signaled. For example, the NCR may provide feedback corresponding to dynamically indicated beams at the NCR for reception and/or transmission of forwarding signals.

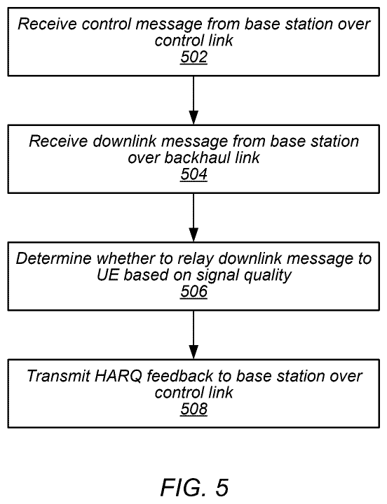

### FIG. 5—Flowchart for an NCR Providing HARQ Feedback for Downlink Forwarding

FIG. 5 illustrates an example of a flowchart diagram for a method for providing HARQ-ACK feedback by a NCR during downlink forwarding, according to some embodiments. Aspects of the method of FIG. 5 may be implemented by a network-controlled repeater (NCR), e.g., in communication with a cellular base station such as BS 102 and one or more UEs 106A-N as illustrated in and described with respect to various of the Figures herein, or more generally in conjunction with any of the computer circuitry, systems, devices, elements, or components shown in the above Figures, among others, as desired. For example, a processor (and/or other hardware) of such a device may be configured to cause the device to perform any combination of the illustrated method elements and/or other method elements. Aspects of the method of FIG. 5 may also be implemented from the perspective of the base station or a UE.

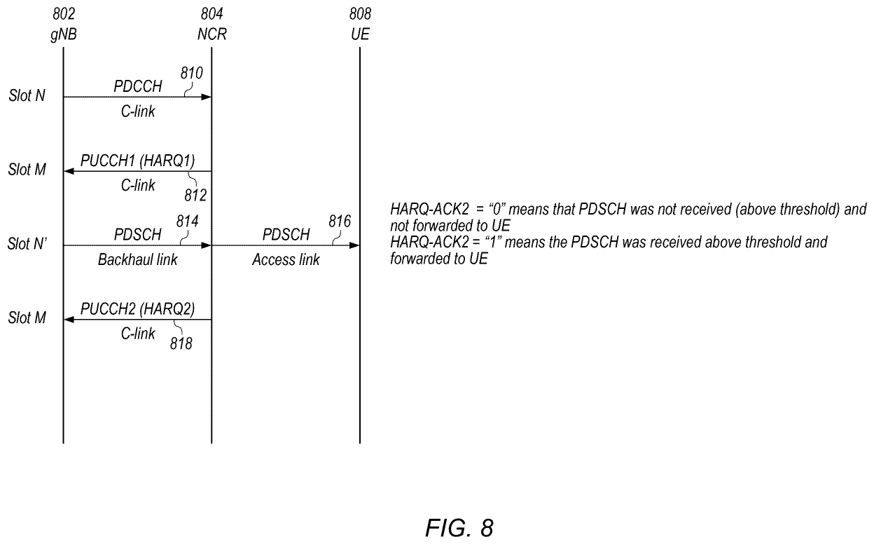

Note that while at least some elements of the method of FIG. 5 are described in a manner relating to the use of communication techniques and/or features associated with 3GPP and/or NR specification documents, such description is not intended to be limiting to the disclosure, and aspects of the method of FIG. 5 may be used in any suitable wireless communication system, as desired. In various embodiments, some of the elements of the methods shown may be performed concurrently, in a different order than shown, may be substituted for by other method elements, or may be omitted. Additional method elements may also be performed as desired. As shown, the method of FIG. 8 may operate as follows.

At 502, a control message is received from a base station over a control link. The control message may be received over a physical downlink control channel (PDCCH). The base station may be a 5^{th} Generation (5G) g Node B (gNB) that transmits the control message to the NCR using a 5G NR RAT. The control message may comprise SCI and may be transmitted over a control link that has been previously established between the base station and the NCR. The control message may configure the NCR for forwarding an upcoming downlink message to one or more UEs. For example, the control message may schedule resources (e.g., time and/or frequency resources) for the upcoming downlink message that the NCR may receive and forward to one or more UEs. Additionally or alternatively, the control message may configure beamforming parameters and/or power control for the NCR to utilize when forwarding the downlink message. The NCR may decode the control message to determine the scheduled resources and/or other parameters for forwarding the downlink message.

In some embodiments, the NCR may be configured by the control message to receive and forward the downlink message in slot N to one or more UE(s), and it may also be configured to report feedback to the base station in slot M (for example via PUSCH or PUCCH) related to the control message and/or the downlink message. Note that the HARQ feedback associated with the control message indicates whether the control message is both received and successfully decoded, whereas the HARQ feedback associated with the downlink message indicates that the downlink message is received with a signal strength that meets a quality threshold (since the downlink message is not decoded).

The slot M for providing HARQ feedback to the base station may be determined based on a slot offset corresponding to slot N which may be either fixed, or semi-statically configured according to NCR capability. HARQ feedback may implement frequency hopping, if supported. The NCR and the base station (BS) may exchange sidelink control information over the control link to configure communications between the NCR and the BS (e.g., to configure resources for providing HARQ feedback) and between the NCR and the UE (e.g., to configure resources for forwarding downlink messages to the UE, or to configure beamforming parameters for exchanging communications with the UE, among other possibilities).

At 504, the downlink message is received from the base station over a backhaul link. The downlink message may be received according to the resources scheduled by the control message. The downlink message may be intended for one or more UEs, and the NCR may subsequently forward the downlink message to the one or more UEs as configured by the network.

At 506, it is determined whether to forward the downlink message to the UE based on the signal quality of the downlink message. For example, it may be determined whether the downlink message was received with a signal quality that exceeds a quality threshold, to determine whether the downlink signal is received at the NCR with sufficient signal strength to reliably forward it to a destination UE. The quality threshold may be an L1-RSRP value of the downlink message. When the signal quality exceeds the quality threshold, the downlink message is transmitted to the UE over an access link. The NCR may transmit the downlink message to the UE without decoding the downlink message. In other words, the NCR may act as a repeater to pass the downlink message along to the UE (e.g., with a boosted signal strength and/or with directed beamforming) without decoding the downlink message. The NCR may implement beamforming when transmitting the downlink message, with beamforming parameters configured through control information received from the base station.

At 508, a hybrid automatic repeat request (HARQ) acknowledgment/negative acknowledgment (ACK/NACK) message is transmitted to the base station over the control link. The HARQ ACK/NACK message indicates whether the downlink message was received with a signal strength that exceeded the quality threshold, and hence whether it was transmitted to the UE.

In some embodiments, and as shown in FIG. 8, a separate HARQ ACK/NACK message is transmitted to the base station over the control link indicating whether the control message was successfully decoded by the NCR. As shown in FIG. 8, the HARQ feedback for the control message may be transmitted prior to the NCR transmitting the downlink message to the UE over the access link. In these embodiments, if the control message HARQ feedback is negative, the gNB may resend the control message prior to sending the downlink message, since the gNB will be informed that the NCR did not successfully decode the control message and therefore may not have access to the scheduled resources for receiving the downlink message.

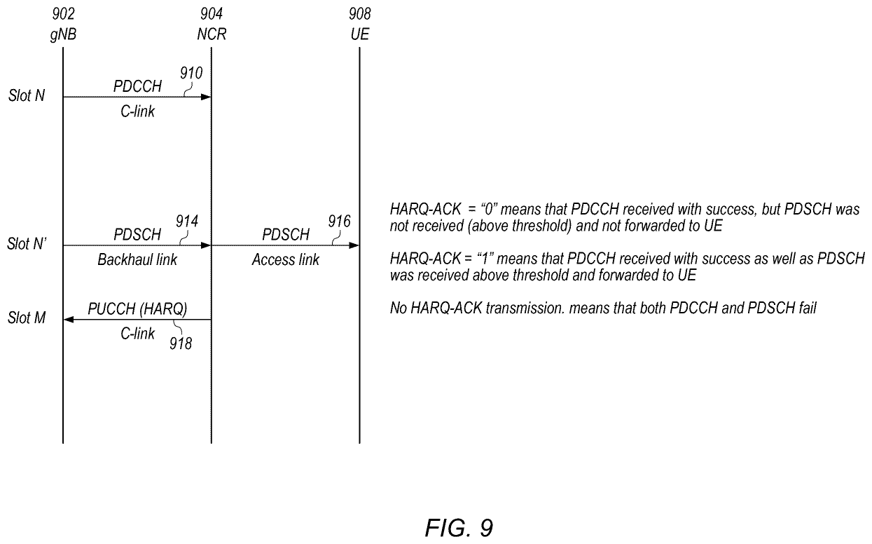

In other embodiments, as shown in FIG. 9, the HARQ ACK/NACK message is a joint feedback message which, in addition to indicating whether the downlink message was forwarded to the UE, further indicates that the control message was successfully decoded by the NCR. In other words, HARQ feedback for receiving both the control message and the downlink message are consolidated into a single joint HARQ message. In these embodiments, a value of the “0” in the HARQ message may indicate that the control message was successfully received but the downlink message was not successfully received (or was received with a signal strength below the quality threshold). A value of “1” in the HARQ message may indicate that both the control message and the downlink message are successfully received (with sufficient signal strength). Finally, the NCR may refrain from transmitting a HARQ ACK/NACK message when the control message (and hence also the downlink message scheduled by the control message) is unsuccessfully received (or received but unsuccessfully decoded), to indicate this to the base station so the base station may resend the control message. The embodiment shown in FIG. 9 preserves resources compared to the method shown in FIG. 8 (by sending fewer HARQ messages), but this advantage is obtained at the cost of extending the time when the base station will be informed if the control message was unsuccessfully decoded by the NCR. Accordingly, either of the embodiments shown in FIG. 8 or 9 may be more desirable in different scenarios, as described in greater detail below.

FIGS. 8 and 9 show two embodiments where HARQ feedback for the control message and the downlink message are sent separately in two HARQ ACK/NACK messages or together in a single message, respectively. In some embodiments, the NCR may determine whether to implement the embodiment shown in FIG. 8 or 9 based on timing offsets between the control message, HARQ feedback for the control message, and the scheduled downlink message. In some embodiments, the timing offset may be quantified as a slot offset between the slots scheduled for the control message, the HARQ feedback, and the downlink message, or another time unit may be used to quantify the timing offset.

For example, the NCR may determine whether a first timing offset between receiving the control message and the scheduled resources for the downlink message exceeds a second timing offset between receiving the control message and providing HARQ feedback for the control message to the base station. When the first timing offset exceeds the second timing offset, the NCR may transmit a separate HARQ ACK/NACK message to the base station over the control link indicating whether the control message was successfully decoded by the NCR (as shown in FIG. 8). Alternatively, as shown in FIG. 9, when the first timing offset does not exceed the second timing offset, the HARQ ACK/NACK message may indicate that both the downlink message and the control message were successfully received by the NCR.

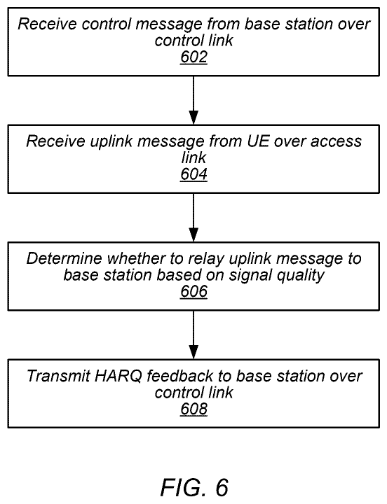

### FIG. 6—Flowchart for an NCR Providing HARQ Feedback for Uplink Forwarding

FIG. 6 illustrates an example of a flowchart diagram for a method for providing HARQ-ACK feedback by a NCR during uplink forwarding, according to some embodiments. Aspects of FIG. 6 are similar to corresponding method steps described in reference to FIG. 5, except that FIG. 6 describes the uplink case whereas FIG. 5 describes the downlink forwarding case. Aspects of the method of FIG. 6 may be implemented by a network-controlled repeater (NCR), e.g., in communication with a cellular base station such as BS 102 and one or more UEs 106A-N as illustrated in and described with respect to various of the Figures herein, or more generally in conjunction with any of the computer circuitry, systems, devices, elements, or components shown in the above Figures, among others, as desired. For example, a processor (and/or other hardware) of such a device may be configured to cause the device to perform any combination of the illustrated method elements and/or other method elements. Aspects of the method of FIG. 6 may also be implemented from the perspective of the base station or a UE.

Note that while at least some elements of the method of FIG. 6 are described in a manner relating to the use of communication techniques and/or features associated with 3GPP and/or NR specification documents, such description is not intended to be limiting to the disclosure, and aspects of the method of FIG. 6 may be used in any suitable wireless communication system, as desired. In various embodiments, some of the elements of the methods shown may be performed concurrently, in a different order than shown, may be substituted for by other method elements, or may be omitted. Additional method elements may also be performed as desired. As shown, the method of FIG. 8 may operate as follows.

At 602, a control message is received from a base station over a control link. The control message may be received over a physical downlink control channel (PDCCH). The BS may be a 5^{th} Generation (5G) g Node B (gNB) that transmits the control message to the NCR using a 5G NR RAT. The control message may comprise SCI and may be transmitted over a control link that has been previously established between the BS and the NCR. The control message may configure the NCR for forwarding an upcoming uplink message from a UE to the BS. For example, the control message may schedule resources (e.g., time and/or frequency resources) for the upcoming uplink message that the NCR is to receive from a UE and forward to the BS. The NCR may decode the control message to determine the scheduled resources for the uplink message. Additionally or alternatively, the control message may configure beamforming parameters and/or power control for the NCR to utilize when forwarding the uplink message.

In some embodiments, the NCR may be configured by the control message to receive and forward the uplink message in slot N to the BS, and it may also be configured to report feedback to the BS in slot M (for example via PUSCH or PUCCH) related to the control message and/or the uplink message, as described in greater detail below. Note that the HARQ feedback associated with the control message indicates whether the control message is both received and successfully decoded, whereas the HARQ feedback associated with the uplink message indicates that the uplink message is received with a signal strength that meets a quality threshold (since the uplink message is not decoded).

The slot M for providing HARQ feedback to the BS may be determined based on a slot offset corresponding to slot N which may be either fixed, or semi-statically configured according to NCR capability. HARQ feedback may implement frequency hopping, if supported. The NCR and the BS may exchange sidelink control information over the control link to configure communications between the NCR and the BS (e.g., to configure resources for providing HARQ feedback) and between the NCR and the UE (e.g., to configure resources for receiving uplink messages to the UE, or to configure beamforming parameters for exchanging communications with the UE, among other possibilities).

At 604, the uplink message is received from the UE over an access link. The uplink message may be received according to the resources scheduled by the control message. The uplink message may be intended for the BS, and the NCR may subsequently forward the uplink message to the BS as configured by the network. The NCR may implement beamforming when receiving the uplink message, with beamforming parameters configured through control information received from the base station. The beamforming parameters may improve the quality of the received uplink message.

At 606, it is determined whether to forward the UL message to the BS based on the signal quality of the uplink message. For example, it may be determined whether the uplink message was received with a signal quality that exceeds a quality threshold, to determine whether the uplink signal is received at the NCR with sufficient signal strength to reliably forward it to BS. The quality threshold may be an L1-RSRP value of the uplink message. When the signal quality exceeds the quality threshold, the uplink message is transmitted to the BS over a backhaul link. The NCR may transmit the uplink message to the BS without decoding the uplink message. In other words, the NCR may act as a repeater to pass the uplink message along to the BS (e.g., with a boosted signal strength and/or with directed beamforming) without decoding the uplink message.

At 608, a hybrid automatic repeat request (HARQ) acknowledgment/negative acknowledgment (ACK/NACK) message is transmitted to the base station over the control link. The HARQ ACK/NACK message indicates whether the uplink message was received with a signal strength that exceeded the quality threshold, and hence whether it was transmitted to the BS.

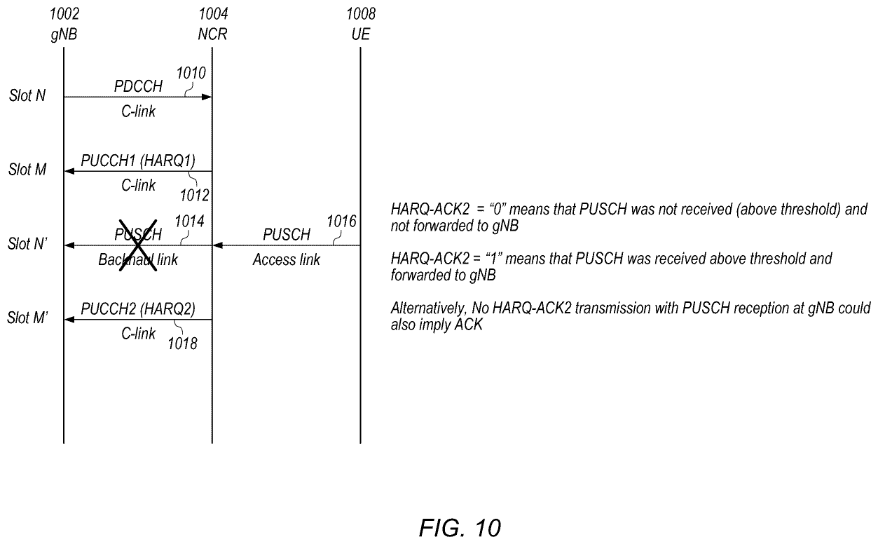

In some embodiments, and as shown in FIG. 10, a separate HARQ ACK/NACK message is transmitted to the base station over the control link indicating whether the control message was successfully decoded by the NCR. As shown in FIG. 10, the HARQ feedback for the control message may be transmitted prior to the NCR receiving the uplink message from the UE over the access link. In these embodiments, if the control message HARQ feedback is negative, the gNB may resend the control message prior to the scheduled reception of the uplink message, since the gNB will be informed that the NCR did not successfully decode the control message and therefore may not have access to the scheduled resources for receiving the uplink message. When the HARQ feedback for the control message and the uplink message are separately transmitted (as in FIG. 10), the HARQ feedback for the uplink message may be set to a “0” (indicating a NACK) when the uplink message is either not received or received with a signal quality below the quality threshold, and may be set to “1” (indicating an ACK) when the uplink message is received with a signal quality that satisfies the quality threshold. Alternatively, to preserve network resources, the NCR may refrain from transmitting HARQ feedback for the uplink message to indicate an ACK (e.g., because forwarding of the uplink message to the base station may implicitly indicate that the uplink message was received with sufficient signal quality).

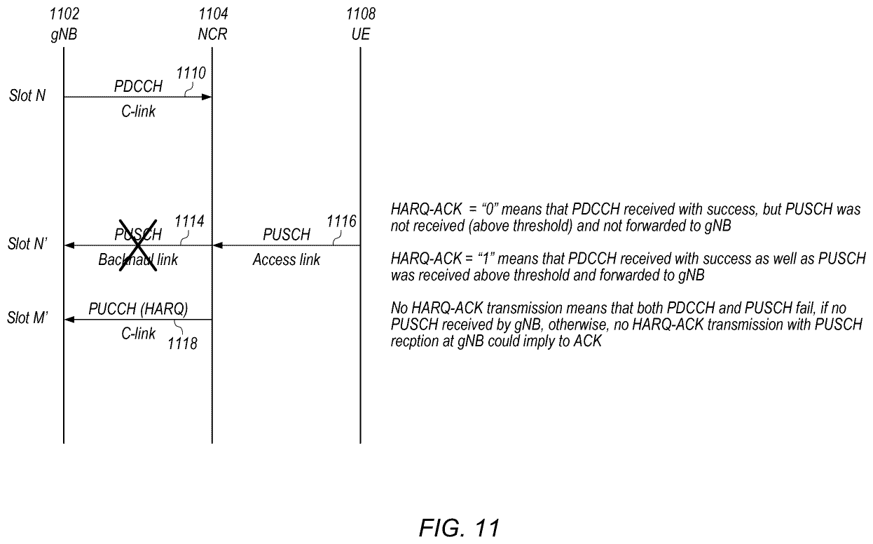

In other embodiments, as shown in FIG. 11, the HARQ ACK/NACK message is a joint feedback message which, in addition to indicating whether the uplink message was received from the UE (e.g., with sufficient signal quality), further indicates that the control message was successfully decoded by the NCR. In other words, HARQ feedback for receiving both the control message and the uplink message are consolidated into a single joint HARQ message. In these embodiments, a value of the “0” in the HARQ message may indicate that the control message was successfully received but the uplink message was not successfully received (or was received with a signal strength below the quality threshold). A value of “1” in the HARQ message may indicate that both the control message and the uplink message are successfully received (with sufficient signal strength). Finally, the NCR may refrain from transmitting a HARQ ACK/NACK message to alternatively indicate 1) when the NCR does not transmit the uplink message to the BS, that the control message (and hence also the uplink message scheduled by the control message) is unsuccessfully received (or received but unsuccessfully decoded), to indicate this to the BS so the BS may resend the control message, or 2) when the NCR does transmit the uplink message to the BS, that both the control message and the uplink message have been successfully received. In other words, depending on whether the NCR transmits the uplink message to the BS, failure to send HARQ feedback may alternatively indicate a NACK for both the control message and the uplink message or an ACK for both the control message and the uplink message. The embodiment shown in FIG. 11 preserves resources compared to the method shown in FIG. 10 (by sending fewer HARQ messages), but this advantage is obtained at the cost of extending the time until the base station will be informed if the control message was unsuccessfully decoded by the NCR. Accordingly, either of the embodiments shown in FIGS. 10 and 11 may be more desirable in different scenarios, as described in greater detail below.

FIGS. 10 and 11 show two embodiments where HARQ feedback for the control message and the uplink message are sent separately in two HARQ ACK/NACK messages or together in a single message, respectively. In some embodiments, the NCR may determine whether to implement the embodiment shown in FIG. 10 or 11 based on timing offsets between the control message, HARQ feedback for the control message, and the scheduled resources for the uplink message. In some embodiments, the timing offset may be quantified as a slot offset between the slots scheduled for the control message, the HARQ feedback, and the downlink message, or another time unit may be used to quantify the timing offset.

For example, the NCR may determine whether a first timing offset between receiving the control message and the scheduled resources for the uplink message exceeds a second timing offset between receiving the control message and providing HARQ feedback for the control message to the base station. When the first timing offset exceeds the second timing offset, the NCR may transmit a separate HARQ ACK/NACK message to the base station over the control link indicating whether the control message was successfully decoded by the NCR (as shown in FIG. 10). Alternatively, as shown in FIG. 11, when the first timing offset does not exceed the second timing offset, the HARQ ACK/NACK message may indicate that both the uplink message and the control message were successfully received by the NCR.

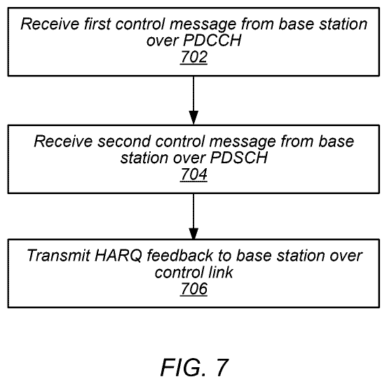

### FIG. 7—Flowchart for an NCR Providing HARQ Feedback for PUCCH and PUSCH

FIG. 7 illustrates an example of a flowchart diagram for a method for providing HARQ-ACK feedback by an NCR that control messaging from a base station over both the PUCCH and the PUSCH, according to some embodiments. Aspects of FIG. 7 are similar in some aspects to FIGS. 5 and 6, and may be used in conjunction with various aspects of these figures. An important distinction of FIG. 7 is that FIG. 7 addresses the circumstance where the NCR receives and provides HARQ feedback for separate PUCCH and PUSCH control messages received from the base station (BS). Aspects of the method of FIG. 7 may be implemented by a network-controlled repeater (NCR), e.g., in communication with a cellular base station such as BS 102 and one or more UEs 106A-N as illustrated in and described with respect to various of the Figures herein, or more generally in conjunction with any of the computer circuitry, systems, devices, elements, or components shown in the above Figures, among others, as desired. For example, a processor (and/or other hardware) of such a device may be configured to cause the device to perform any combination of the illustrated method elements and/or other method elements. Aspects of the method of FIG. 7 may also be implemented from the perspective of the base station or a UE.

Note that while at least some elements of the method of FIG. 7 are described in a manner relating to the use of communication techniques and/or features associated with 3GPP and/or NR specification documents, such description is not intended to be limiting to the disclosure, and aspects of the method of FIG. 7 may be used in any suitable wireless communication system, as desired. In various embodiments, some of the elements of the methods shown may be performed concurrently, in a different order than shown, may be substituted for by other method elements, or may be omitted. Additional method elements may also be performed as desired. As shown, the method of FIG. 7 may operate as follows.

At 702, a first control message is received from a BS over a control link. The first control message may be received over a physical downlink control channel (PDCCH). The BA may be a 5^{th} Generation (5G) g Node B (gNB) that transmits the first control message to the NCR using a 5G NR RAT. The first control message may comprise first control information and may be transmitted over a control link that has been previously established between the BS and the NCR. The first control information may schedule resources (e.g., time and/or frequency resources), beamforming parameters, and/or power parameters for an upcoming downlink or uplink message that the NCR is to forward between the BS and one or more UEs. The first control information may also schedule resources for the second control message. The NCR may decode the first control message to determine the scheduled resources for the downlink or uplink message. The NCR may be configured to provide HARQ feedback to the BS to indicate whether the first control message is successfully decoded, which may be combined or separate from HARQ feedback provided for a second control message, as described below.

At 704, a second control message is received from the BS over the control link. The second control message may be received over a physical downlink shared channel (PDSCH), and may contain a medium access control (MAC) control element (CE) that includes second control information to schedule resources or configure beamforming or power parameters for the NCR to utilize in forwarding messages between the BS and the one or more UEs. In various embodiments, control information (resource scheduling, beamforming parameters, and power parameters) may be allocated between the first and second control messages in various ways. The NCR may decode the second control message and may be configured to provide HARQ feedback to the BS to indicate whether the second control message is successfully decoded.

At 706, a hybrid automatic repeat request (HARQ) acknowledgment/negative acknowledgment (ACK/NACK) message is transmitted to the base station over the control link. The HARQ ACK/NACK message indicates whether the second control message was successfully decoded.

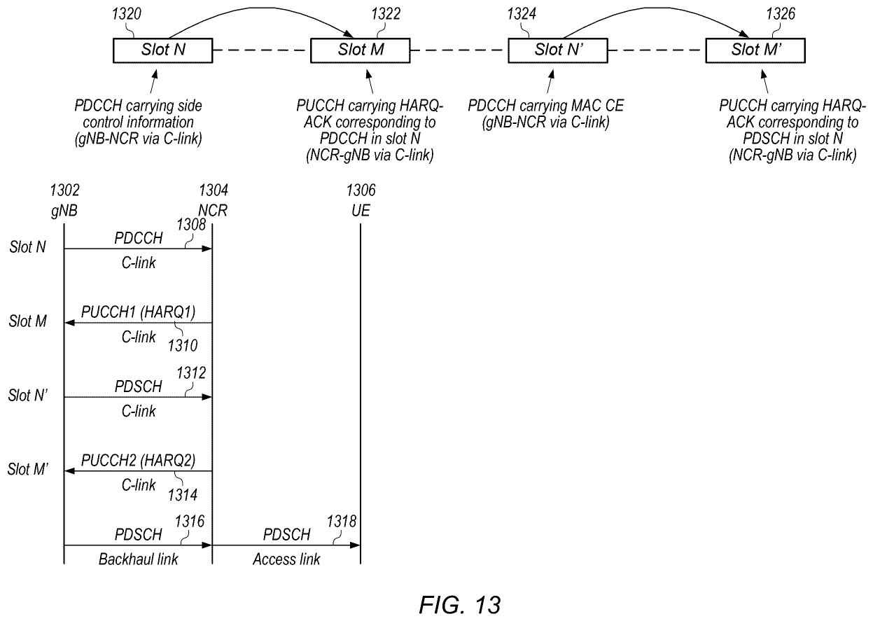

In some embodiments, and as shown in FIG. 12, a separate HARQ ACK/NACK message is transmitted to the base station over the control link indicating whether the first control message was successfully decoded by the NCR. As shown in FIG. 12, the HARQ feedback for the first control message may be transmitted prior to the NCR receiving the second control message.

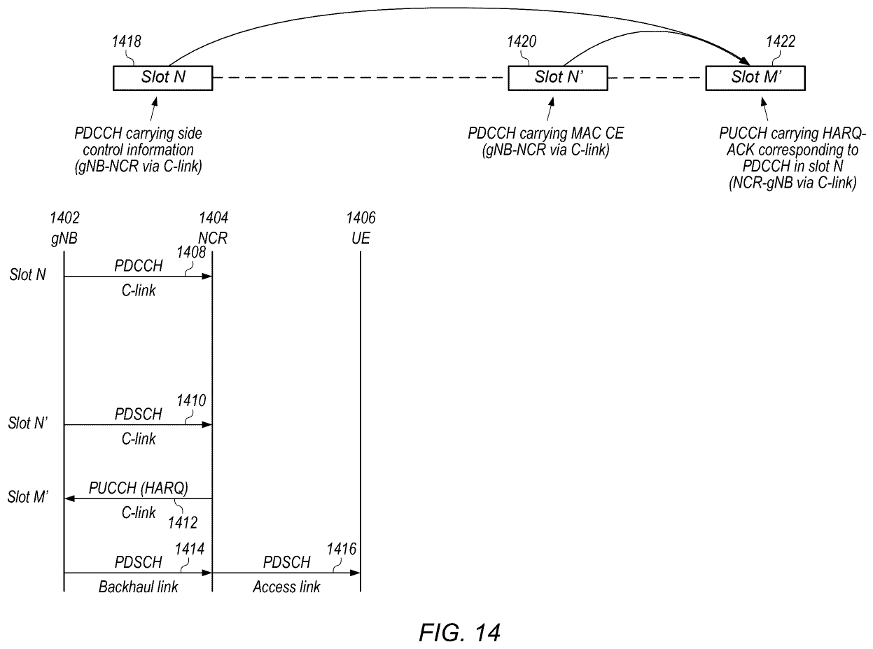

In other embodiments, as shown in FIG. 13, the HARQ ACK/NACK message is a joint feedback message which, in addition to indicating whether the second control message was successfully decoded, further indicates that the first control message was successfully decoded by the NCR. In other words, HARQ feedback for receiving both the first and second control messages are consolidated into a single joint HARQ message. In these embodiments, a value of the “0” in the HARQ message may indicate that the first control message was successfully received but the second control message was not successfully received (or was received with a signal strength below the quality threshold). A value of “1” in the HARQ message may indicate that both the first and second control messages are successfully received and decoded. Finally, the NCR may refrain from transmitting any HARQ ACK/NACK messages to indicate that both the first and second control messages were either not received or received but unsuccessfully decoded.

The embodiment shown in FIG. 13 preserves resources compared to the method shown in FIG. 12 (by sending fewer HARQ messages), but this advantage is obtained at the cost of extending the time until the base station will be informed if the first control message was unsuccessfully decoded by the NCR. Accordingly, either of the embodiments shown in FIGS. 12 and 13 may be more desirable in different scenarios, as described in greater detail below.

FIGS. 12 and 13 show two embodiments where HARQ feedback for the first and second control messages are sent separately in two HARQ ACK/NACK messages or together in a single message, respectively. In some embodiments, the NCR may determine whether to implement the embodiment shown in FIG. 12 or 13 based on timing offsets between the first control message, HARQ feedback for the first control message, and the second control message. In some embodiments, the timing offset may be quantified as a slot offset between the slots scheduled for the control message, the HARQ feedback, and the downlink message, or another time unit may be used to quantify the timing offset.

For example, the NCR may determine whether a first timing offset between receiving the first control message and the second control message exceeds a second timing offset between receiving the first control message and providing HARQ feedback for the first control message to the base station. When the first timing offset exceeds the second timing offset, the NCR may transmit a separate HARQ ACK/NACK message to the base station over the control link indicating whether the first control message was successfully decoded by the NCR (as shown in FIG. 12). Alternatively, as shown in FIG. 13, when the first timing offset does not exceed the second timing offset, the HARQ ACK/NACK message may provide joint feedback for both the first and second control messages.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Embodiments of the present disclosure may be realized in any of various forms. For example, some embodiments may be realized as a computer-implemented method, a computer-readable memory medium, or a computer system. Other embodiments may be realized using one or more custom-designed hardware devices such as ASICs. Still other embodiments may be realized using one or more programmable hardware elements such as FPGAs.

In some embodiments, a non-transitory computer-readable memory medium may be configured so that it stores program instructions and/or data, where the program instructions, if executed by a computer system, cause the computer system to perform a method, e.g., any of the method embodiments described herein, or, any combination of the method embodiments described herein, or, any subset of any of the method embodiments described herein, or, any combination of such subsets.

In some embodiments, a device (e.g., a UE 106) may be configured to include a processor (or a set of processors) and a memory medium, where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The device may be realized in any of various forms.

Any of the methods described herein for operating a user equipment (UE) may be the basis of a corresponding method for operating a base station, by interpreting each message/signal X received by the UE in the downlink as message/signal X transmitted by the base station, and each message/signal Y transmitted in the uplink by the UE as a message/signal Y received by the base station.

Although the embodiments above have been described in considerable detail, numerous variations and modifications will become apparent to those skilled in the art once the above disclosure is fully appreciated. It is intended that the following claims be interpreted to embrace all such variations and modifications.

1-29. (canceled)

30. A method, comprising:
by a network-controlled repeater (NCR):
receiving a first control message from a base station (BS) over a physical downlink control channel (PDCCH), wherein the control message comprises first control information;
receiving a second control message from the BS over a physical downlink shared channel (PDSCH), wherein the second control message comprises second control information including information to configure beamforming parameters for the NCR to utilize in forwarding messages between the BS and one or more user equipment (UE) devices; and
transmitting a hybrid automatic repeat request (HARQ) acknowledgment/negative acknowledgment (ACK/NACK) message to the BS, wherein the HARQ ACK/NACK message indicates whether the second control message was successfully decoded.

31. The method of claim 30, further comprising:
decoding the first control message to determine:
scheduled resources for an upcoming message to be forwarded between the BS and the one or more UE devices; and
beamforming parameters for the upcoming message.

32. The method of claim 30, further comprising:
decoding the first control message to determine scheduled resources for the second control message.

33. The method of claim 30, further comprising:
decoding the second control message which includes control information to configure beamforming parameters for the NCR to utilize in forwarding messages between the BS and the one or more UEs.

34. The method of claim 30, further comprising:
decoding the second control message which includes resource scheduling for the NCR to utilize in forwarding messages between the BS and the one or more UEs.

35. The method of claim 34, wherein the scheduled resources are time resources.

36. The method of claim 30,
wherein the first control information is received over a physical downlink control channel (PDCCH), and
wherein the second control information is received over a physical downlink shared channel (PDSCH) and comprises a medium access channel (MAC) control element (CE).

37. The method of claim 30,
wherein the NCR communicates with the BS using a 5th Generation New Radio (5G NR) RAT, and
wherein the BS comprises a g Node B (gNB).

38. A network-controlled repeater (NCR) comprising:
at least one antenna;
at least one radio, wherein the at least one radio is configured to perform cellular communication using at least one radio access technology (RAT);
one or more processors coupled to the at least one radio, wherein the one or more processors and the at least one radio are configured to perform communications;
wherein the one or more processors are configured to cause the NCR to:
receive a first control message on a control link from a base station (BS) over a physical downlink control channel (PDCCH), wherein the control message comprises first control information;
determine, from the first control message, scheduled resources for an upcoming message to be forwarded between the BS and one or more user equipment (UE) devices and beamforming parameters for the upcoming message;
receive a second control message on the control link from the BS over a physical downlink shared channel (PDSCH), wherein the second control message comprises second control information including information to configure beamforming parameters for the NCR to utilize in forwarding messages between the BS and the one or more UE devices; and
transmit a hybrid automatic repeat request (HARQ) acknowledgment/negative acknowledgment (ACK/NACK) message on the control link to the BS, wherein the HARQ ACK/NACK message indicates whether the second control message was successfully decoded.

39. The NCR of claim 38, wherein the one or more processors are further configured to cause the NCR to:
decode the second control message which includes resource scheduling for the NCR to utilize in forwarding messages between the BS and the one or more UEs.

40. The NCR of claim 39, wherein the scheduled resources are time resources.

41. The NCR of claim 38,
wherein the first control information is received over a physical downlink control channel (PDCCH), and
wherein the second control information is received over a physical downlink shared channel (PDSCH) and comprises a medium access channel (MAC) control element (CE).

42. The NCR of claim 38,
wherein the at least one RAT comprises a 5^{th} Generation New Radio (5G NR) RAT, and
wherein the BS comprises a g Node B (gNB).

43. An apparatus, comprising:
a processor configured to cause a base station (BS) to:
transmit a first control message to a network-controlled repeater over a physical downlink control channel (PDCCH), wherein the control message comprises first control information;
transmit a second control message to the NCR over a physical downlink shared channel (PDSCH), wherein the second control message comprises second control information including information to configure beamforming parameters for the NCR to utilize in forwarding messages between the BS and one or more user equipment (UE) devices; and
receive a hybrid automatic repeat request (HARQ) acknowledgment/negative acknowledgment (ACK/NACK) message from the NCR, wherein the HARQ ACK/NACK message indicates whether the second control message was successfully decoded.

44. The apparatus of claim 43:
wherein the first control message is useable to determine:
scheduled resources for an upcoming message to be forwarded between the BS and the one or more UE devices; and
beamforming parameters for the upcoming message.

45. The apparatus of claim 43,
wherein the first control message is useable to determine scheduled resources for the second control message.

46. The apparatus of claim 43,
wherein the second control message includes control information to configure beamforming parameters for the NCR to utilize in forwarding messages between the BS and the one or more UEs.

47. The apparatus of claim 43,
wherein the second control message includes resource scheduling for the NCR to utilize in forwarding messages between the BS and the one or more UEs.

48. The apparatus of claim 47, wherein the scheduled resources are time resources.

49. The apparatus of claim 43,
wherein the first control information is received over a physical downlink control channel (PDCCH), and
wherein the second control information is received over a physical downlink shared channel (PDSCH) and comprises a medium access channel (MAC) control element (CE).
